(19) United States
(12) Patent Application Publication
(10) Pub. No.: US 2005/0265177 A1
(43) Pub. Date: Dec. 1, 2005

(54) Fully automatic control method of spindle motor of optical disc drive

(76) Inventors: Jan-Tang Wu, Taipei (TW); Wei-Chung Wu, Taipei (TW)

Correspondence Address: BIRCH STEWART KOLASCH & BIRCH, PO BOX 747, FALLS CHURCH, VA, 22040-0747, US

(21) Appl. No.: 10/891,004

(22) Filed: Jul. 15, 2004

(30) Foreign Application Priority Data
May 25, 2004 (TW) 093114843

(51) Int. Cl. G11B 5/09; G11B 7/00

(52) U.S. Cl. 369/47.36; 369/47.1

(57) ABSTRACT

A fully automatic control method of a spindle motor of an optical disc drive detects a firmware value stored in the optical disc drive; sets a fully automatic control mode of the spindle motor of the optical disc drive; receives a signal of the spindle motor of the optical disc drive or a reflected signal of an optical disc; and automatically switches a read mode and the speed of the spindle motor of the optical disc drive according to the received signal.

### FIELD OF THE INVENTION

The present invention relates to a fully automatic control method of a spindle motor of an optical disc drive and, more particularly, to a method capable of automatically controlling a spindle motor of an optical disc drive.

### BACKGROUND OF THE INVENTION

In order to accomplish stable and quick operations and correct readout of signals, the control method of optical disc drives like CD-ROM, CD-R, CD-R/W or DVD is becoming more and more important.

There are four modes for control of a spindle motor of an optical disc drive. The first is an FG mode (also called a constant angular velocity (CAV) mode), in which the signal of a Hall generator or a frequency generator is used as a feedback signal for control of the rotation speed of the spindle motor of the optical disc drive.

The second is a WBL mode, in which a wobble signal on an optical disc is read. The wobble signal read from an optical disc is used as a feedback signal for control of the rotation speed of the spindle motor of the optical disc drive.

The third is a DEC mode, in which regions with data on an optical disc are read. In these regions, there will be a radio frequency (RF) signal that can be used as a feedback signal. Control of the rotation speed of the spindle motor is handed over to a digital signal processor (DSP).

The fourth is an AX mode, which can be seen as a special case of the WBL mode. During write-in of a CD-R/W, it is necessary to let the absolute time in pre-groove sync (ATIP sync) and the encoder subcode frame sync (ESFS) be synchronous for correct recording of data on the optical disc. Conventionally, there is only a control mode for the spindle motor. Sometimes, there are regions that have already been recorded in and blank regions coexistent on an optical disc. When an optical pick-up head reads data alternately from the regions that have already been recorded and the blank regions, a manual switching mode is conventionally used. The manual switching mode, however, usually responds too late.

### SUMMARY AND OBJECTS OF THE PRESENT INVENTION

The primary object of the present invention is to provide a fully automatic control method of a spindle motor of an optical disc drive so that system operators can conveniently control the spindle motor of the optical disc drive.

To achieve the above object, the present invention provides a fully automatic control method of a spindle motor of an optical disc drive comprising the steps of: detecting a firmware value stored in the optical disc drive; setting a fully automatic control mode of the spindle motor of the optical disc drive; receiving a signal of the spindle motor of the optical disc drive or a reflected signal of an optical disc; and automatically switching a read mode and the speed of the spindle motor of the optical disc drive according to the received signal.

### BRIEF DESCRIPTION OF DRAWINGS

The various objects and advantages of the present invention will be more readily understood from the following detailed description when read in conjunction with the appended drawings, in which:

FIG. 1 is a timing diagram of an FG/DEC auto mode of the present invention;

FIG. 2 is a timing diagram of an FG/WBL auto mode of the present invention;

FIG. 3 is a timing diagram of an FG/WBL/DEC auto mode of the present invention;

FIG. 4 is a timing diagram of a WBL/AX auto mode of the present invention;

FIG. 5 is a flowchart of a fully automatic control method of a spindle motor of an optical disc drive of the present invention; and

FIG. 6 is a flowchart of a fully automatic control method of a spindle motor of an optical disc drive according to a preferred embodiment of the present invention.

### DETAILED DESCRIPTION OF PREFERRED EMBODIMENT

For common uses, there is only a control mode for one spindle motor at a time. Sometimes, there are regions that have already been recorded and blank regions coexistent on an optical disc. When an optical pick-up head reads data alternately from the regions that have already been recorded and the blank regions, a manual switching mode is conventionally used. The manual switching mode, however, usually responds too late. Therefore, it is necessary to switch between different modes according to different situations of the optical disc drive.

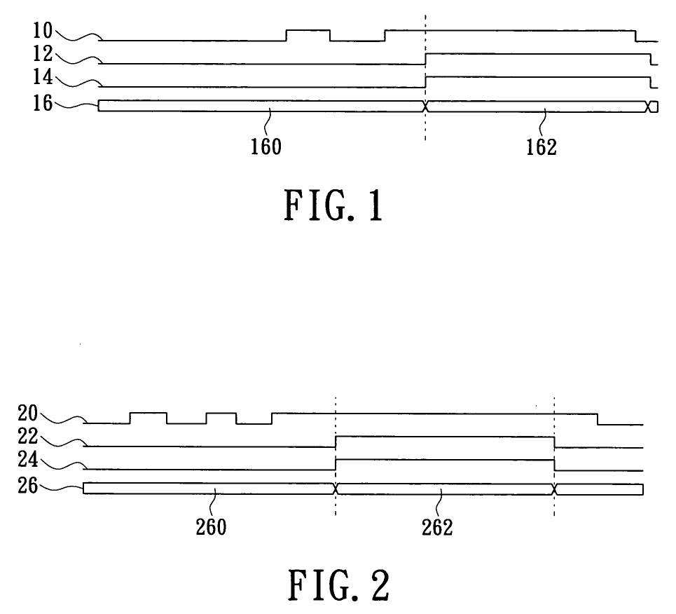

The fully automatic switching modes of a spindle motor of an optical disc drive of the present invention can be divided into four kinds. FIG. 1 shows the first mode: an FG/DEC auto mode. If the optical disc drive is set to the FG/DEC auto mode 16, when a TRKON signal 10 and an SPLOCK signal 12 aren't simultaneously at the high level, the control method of motor is a FG mode 160. When the TRKON signal and the SPLOCK signal are simultaneously at the high level, the control way of motor is switched to a DEC mode 162 because an RF signal is used as the feedback signal in the DEC mode.

In addition to the application for the regions that have already been recorded and the regions that haven't recorded yet, this mode can also be used for seeking. When tracking follow is performed, if a tracking error (TE) signal is controlled properly, a DSP will set the TRKON signal to high. At this time, the control way of motor is the DEC mode. When seeking is performed, the DSP will set the TRKON signal back to low to let the motor enter the FG mode.

The TRKON signal is a flag for whether the pick-up head has entered the tracking follow mode, i.e., whether the laser head has been locked on the track. The SPLOCK signal is a flag for whether the eight-to-fourteen modulation sync (EFM sync) has been successfully detected several times, representing that readout of data is already stable.

FIG. 2 shows a second mode: a FG/WBL auto mode. If the spindle motor of the optical disc drive is set to the FG/WBL auto mode 26, when the optical disc drive is activated, whether the TRKON signal is at the high level is confirmed. During this period, the motor is controlled by an FG mode 260. When tracking follow is performed, if the TRKON signal 20 and the WBLOCK signal 22 aren't simultaneously at the high level, the control way of motor still stays in the FG mode 260. If the TRKON signal 20 and the WBLOCK signal 22 are simultaneously at the high level, the control method of the motor is switched to the WBL mode 262, representing that control of the rotation speed of motor is very stable. The occasion of use is the same as the FG/WBL mode.

The TRKON signal is a flag for whether the pick-up head has entered the tracking follow mode. The WBLOCK signal is a flag for whether the rotation speed of motor is stable.

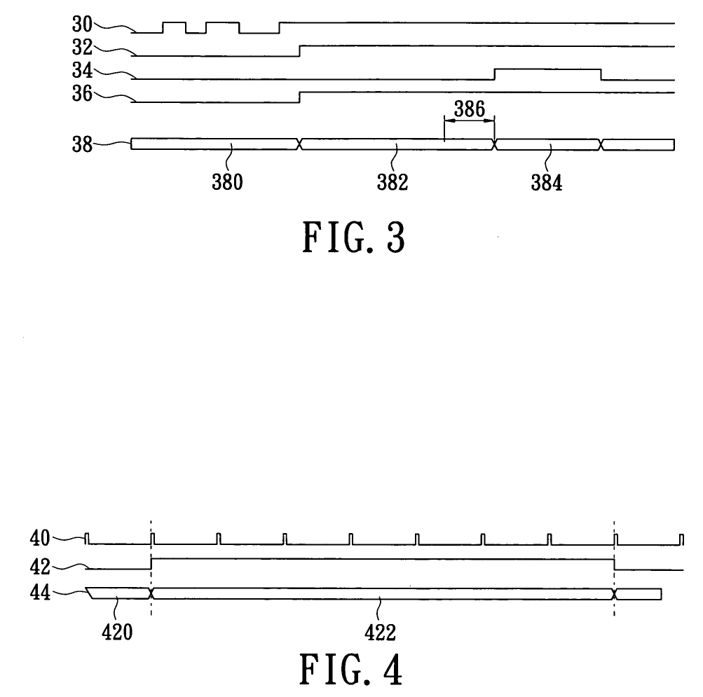

FIG. 3 shows a third mode: an FG/WBL/DEC auto mode. If the optical disc drive is set to the FG/WBL/DEC auto mode 38, when the optical disc drive is activated, the working method is roughly the same as the FG/WBL auto mode. When the control mode enters the WBL mode, however, if the TRLOCK signal 34 is at the high level, the control mode switches the DEC mode 384. If the TRLOCK signal 34 is at the low level, the control mode switches to the WBL mode 382. When the TRKON signal 30 and the WBLOCK signal 32 are simultaneously at the low level, the control mode switches back to the FG mode 380.

When whether data have been written in an optical disc is not sure, this mode can be used. When data have been read (i.e., when the TRLOCK signal 34 is at the high level), the control mode switches to the DEC mode. Before switching to the DEC mode 384, the WBL mode 382 is maintained for a period of time (i.e., the continual check time for EFM sync 386) to ensure there really is a signal. If regions without data are met, the control mode switches to the WBL mode 382. If it is necessary to seek, the control mode switches to the FG mode 380. This mode is used especially for discontinuous recording in an optical disc.

The TRKON signal 30 is a flag for whether the pick-up head has entered the tracking follow mode. The TRLOCK signal is a flag for whether the eight-to-fourteen modulation sync (EFM sync) has been successfully detected several times (the number of detection times is different from that of the SPLOCK signal), representing that readout of data is already stable.

FIG. 4 shows a fourth mode: a WBL/AX auto mode. When the optical disc drive is set to the WBL/AX auto mode 44, if the optical disc drive is to enter the recording state, the WBL mode 440 will be used as the start mode. After recording, a WC_WRITE signal 42 will be pulled to the high level. At this time, the spindle motor will switch to the AX mode 442, which is used for synchronization of the ATIP sync and the ESFS 40.

When recording is interrupted due to buffer under run or other situations (e.g., the focus error (FE) signal or the tracking error (TE) signal is too bad), the WC_WRITE signal will be at the low level, and the motor control mode will be switched back to the WBL mode until the WC_WRITE signal becomes high level. The motor control mode will then be switched to the AX mode. The AX mode is a flag for preparatory write-in of data.

Applications of the above four auto modes will change according to the types of recordable discs (R or R/W). System operators can thus conveniently control the spindle motor in real time to enhance the recording quality.

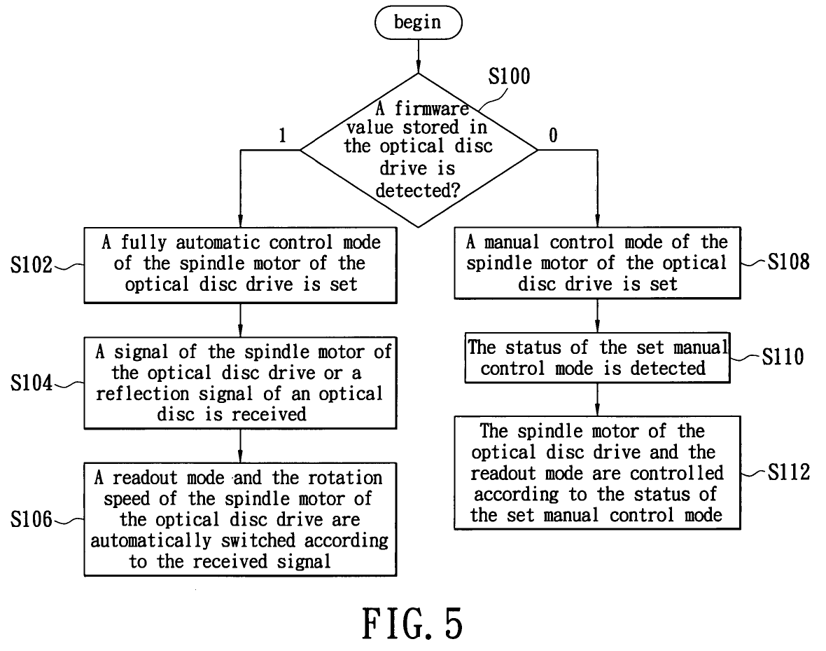

As shown in FIG. 5, a fully automatic control method of a spindle motor of an optical disc drive of the present invention comprises the following steps. First, a firmware value stored in the optical disc drive is detected (Step S100). This firmware value can be 1 or 0. If the detection result is 1, a fully automatic control mode of the spindle motor of the optical disc drive is set (Step S102). A signal of the spindle motor of the optical disc drive or a reflection signal of an optical disc is received (Step S104). A readout mode and the rotation speed of the spindle motor of the optical disc drive are switched according to the received signal (Step S106).

In the step of detecting a firmware value stored in the optical disc drive, if the detection result is 0, the fully automatic control method of a spindle motor of an optical disc drive of the present invention further comprises the steps of: setting a manual control mode of the spindle motor of the optical disc drive (Step S108); detecting the status of the set manual control mode (Step S110); and controlling the spindle motor of the optical disc drive and a readout mode according to the status of the manual control mode.

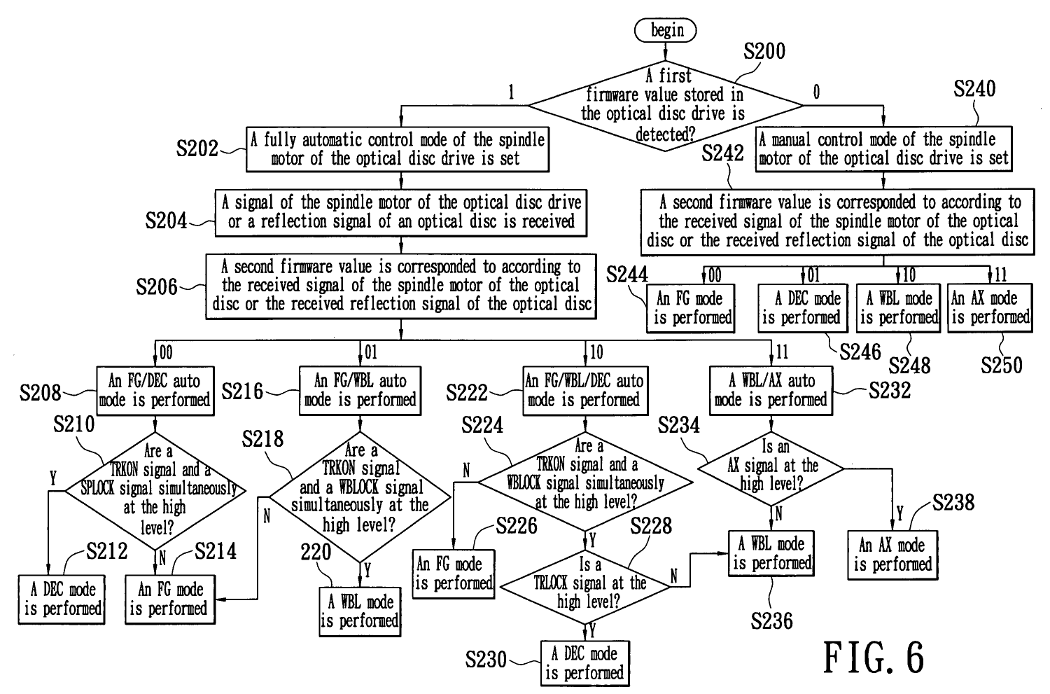

FIG. 6 is a flowchart of a fully automatic control method of a spindle motor of an optical disc drive according to a preferred embodiment of the present invention. First, a first firmware value stored in the optical disc drive is detected (Step S200). This first firmware value can be 1 or 0. If the detection result is 1, a fully automatic control mode of the spindle motor of the optical disc drive is set (Step S202). A signal of the spindle motor of the optical disc drive or a reflection signal of an optical disc is received (Step S204). A second firmware value stored in the optical disc drive is corresponded to according to the received signal of the spindle motor of the optical disc drive or the reflection signal of the optical disc (Step S206).

The above second firmware value includes four kinds of different parameters: 00, 01, 10 and 11. If the second firmware value is 00, an FG/DEC auto mode is performed (Step 208). Next, whether a TRKON signal and a SPLOCK signal are simultaneously at the high level is determined (Step S210). If the answer is yes, a DEC mode is performed (Step S212); otherwise, an FG mode is performed (Step S214).

In the step of corresponding to a second firmware value stored in the optical disc drive according to the received signal of the spindle motor of the optical disc drive or the reflection signal of the optical disc, if the second firmware value is 01, an FG/WBL auto mode is performed (Step S216). Next, whether a TRKON signal and a WBLOCK signal are simultaneously at the high level is determined (Step S218). If the answer is yes, a WBL mode is performed (Step S220); otherwise, an FG mode is performed (Step S214).

In the step of corresponding to a second firmware value stored in the optical disc drive according to the received signal of the spindle motor of the optical disc drive or the reflection signal of the optical disc, if the second firmware value is 10, an FG/WBL/DEC auto mode is performed (Step S222). Next, whether a TRKON signal and a WBLOCK signal are simultaneously at the high level is determined (Step S224). If the answer is yes, whether TRLOCK signal is at the high level is further determined (Step S228); otherwise, an FG mode is performed (Step S226). If the TRLOCK is at the high level, a DEC mode is performed (Step S230); otherwise, a WBL mode is performed (Step S236).

In the step of corresponding to a second firmware value stored in the optical disc drive according to the received signal of the spindle motor of the optical disc drive or the reflection signal of the optical disc, if the second firmware value is 11, a WBL/AX auto mode is performed (Step S232). Next, whether an AX signal is at the high level is determined (Step S234). If the answer is yes, an AX mode is performed (Step S238); otherwise, a WBL mode is performed (Step S236).

In the step of detecting a first firmware value stored in the optical disc drive, if the detection result is 0, a manual control mode of the spindle motor of the optical disc drive is set (Step S240). Next, a second firmware value stored in the optical disc drive is corresponded to according to the received signal of the spindle motor of the optical disc drive or the reflection signal of the optical disc (Step S242). The second firmware value includes four kinds of different parameters: 00, 01, 10, and 11. If the second firmware value is 00, an FG mode is performed (Step S244). If the second firmware value is 01, a DEC mode is performed (Step S246). If the second firmware value is 10, a WBL mode is performed (Step S248). If the second firmware value is 11, an AX mode is performed (Step S250).

To sum up, there is only a manual mode for control of a spindle motor of an optical disc drive in the prior art. That is, if the firmware of an optical disc drive is set to a DEC mode, the spindle motor of the optical disc drive can only be controlled using the DEC mode. The spindle motor of the optical disc drive won't switch to a different mode in response to later signals. The present invention provides a fully automatic control method of a spindle motor of an optical disc drive so that system operators can conveniently control the spindle motor of the optical disc drive.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modification are intended to be embraced within the scope of the invention as defined in the appended claims.

1. A fully automatic control method of a spindle motor of an optical disc drive, comprising the steps of:
detecting a firmware value stored in said optical disc drive;
setting a fully automatic control mode of said spindle motor of said optical disc drive;
receiving a signal of said spindle motor of said optical disc drive or a reflection signal of an optical disc; and
switching a readout mode and a rotation speed of said spindle motor of said optical disc drive according to said received signal.

2. The fully automatic control method of a spindle motor of an optical disc drive as claimed in claim 1, wherein a next step is performed if the detection result is 1 in said step of detecting a firmware value stored in said optical disc drive, and the fully automatic control method otherwise further comprises the steps of:
setting a manual control mode of said spindle motor of said optical disc drive;
detecting a status of said set manual control mode; and
controlling said spindle motor of said optical disc drive and a readout mode according to the status of said set manual control mode.

3. A fully automatic control method of a spindle motor of an optical disc drive, comprising the steps of:
detecting a first firmware value stored in said optical disc drive;
setting a fully automatic control mode of said spindle motor of said optical disc drive;
receiving a signal of said spindle motor of said optical disc drive or a reflection signal of an optical disc;
corresponding to a second firmware value stored in said optical disc drive according to said received signal of said spindle motor of said optical disc drive or said received refection signal of said optical disc; and
performing an FG/DEC auto mode.

4. The fully automatic control method of a spindle motor of an optical disc drive as claimed in claim 3, wherein a next step is performed if the detection result is 1 in said step of detecting a first firmware value stored in said optical disc drive, and the fully automatic control method otherwise further comprises the steps of:
setting a manual control mode of said spindle motor of said optical disc drive; and
corresponding to a second firmware value stored in said optical disc drive according to said received signal of said spindle motor of said optical disc drive or said received refection signal of said optical disc.

5. The fully automatic control method of a spindle motor of an optical disc drive as claimed in claim 3, wherein an FG/DEC auto mode is performed if said second firmware value stored in said optical disc drive is 00.

6. The fully automatic control method of a spindle motor of an optical disc drive as claimed in claim 3, wherein an FG/WBL auto mode is performed if said second firmware value stored in said optical disc drive is 01.

7. The fully automatic control method of a spindle motor of an optical disc drive as claimed in claim 3, wherein an FG/WBL/DEC auto mode is performed if said second firmware value stored in said optical disc drive is 10.

8. The fully automatic control method of a spindle motor of an optical disc drive as claimed in claim 3, wherein a WBL/AX auto mode is performed if said second firmware value stored in said optical disc drive is 11.

9. The fully automatic control method of a spindle motor of an optical disc drive as claimed in claim 3, wherein said step of performing an FG/DEC auto mode further comprises the steps of:
determining whether a TRKON signal and an SPLOCK signal are simultaneously at a high level;
performing a DEC mode if an answer is yes; and
performing an FG mode if the answer is no.

10. The fully automatic control method of a spindle motor of an optical disc drive as claimed in claim 6, wherein said step of performing an FG/WBL auto mode further comprises the steps of:
determining whether a TRKON signal and an WBLOCK signal are simultaneously at a high level;
performing a WBL mode if an answer is yes; and
performing an FG mode if the answer is no.

11. The fully automatic control method of a spindle motor of an optical disc drive as claimed in claim 7, wherein said step of performing an FG/WBL/DEC auto mode further comprises the steps of:
determining whether a TRKON signal and an WBLOCK signal are simultaneously at a high level;
determining whether a TRLOCK signal is at the high level if an answer is yes; and
performing an FG mode if the answer is no.

12. The fully automatic control method of a spindle motor of an optical disc drive as claimed in claim 11, wherein a DEC mode is performed if the answer is yes in said step of determining whether the TRLOCK signal is at the high level, and if the answer is no, a WBL mode is performed.

13. The fully automatic control method of a spindle motor of an optical disc drive as claimed in claim 8, wherein said step of performing a WBL/AX auto mode further comprises the steps of:
determining whether an AX signal is at the high level;
performing an AX mode if the answer is yes; and
performing a WBL mode if the answer is no.
